(19) United States
(12) Patent Application Publication
(10) Pub. No.: US 2025/0136088 A1
(43) Pub. Date: May 1, 2025

(54) CONTROL SYSTEM FOR DETERMINING A REFERENCE SIDE AREA FOR A VEHICLE ENTITY

(71) Applicant: Volvo Truck Corporation, Göteborg (SE)

(72) Inventors: Leo LAINE, Härryda (SE); Kristoffer TAGESSON, Hammarö (SE); Mikael ASKERDAL, Åsa (SE)

(21) Appl. No.: 18/835,763

(22) PCT Filed: Feb. 11, 2022
(86) PCT No.: PCT/EP2022/053306

§ 371 Date: Aug. 5, 2024

(51) Int. Cl. B60W 30/04; B60G 17/0165; B60W 10/22; B60W 40/02

(52) U.S. Cl. CPC B60W 30/04; B60G 17/0165; B60W 10/22; B60W 40/02; B60G 2400/0511; B60G 2400/60; B60G 2400/841; B60W 2520/18; B60W 2530/10; B60W 2555/20

(57) ABSTRACT

A control system for determining a reference side area for a vehicle entity. The vehicle entity is a vehicle or a vehicle trailer and having a nominal vehicle entity side area. The reference side area is adapted to be multiplied with a side force coefficient for determining a side force parameter proportional to a wind side force load imparted on the vehicle entity and/or to be multiplied with a lift coefficient for determining a lift parameter proportional to a wind lift load imparted on the vehicle entity and/or to be combined with a drag coefficient for determining a drag load imparted on the vehicle entity. The vehicle entity comprises a load surface adapted to receive a material load such that at least a portion of the material load can be exposed to wind loads. The load surface being associated with a load surface area and a load surface length.

### TECHNICAL FIELD

The invention relates to a control system for determining a reference side area for a vehicle entity. Moreover, the invention relates to a vehicle entity. Additionally, the invention relates to a method for determining a reference side area for a vehicle entity.

The invention can be applied in heavy-duty vehicles, such as trucks, buses and construction equipment. Although the invention will be described with respect to a truck, the invention is not restricted to this particular vehicle, but may also be used in other vehicles such as wheel loaders, haulers or the like.

### BACKGROUND

A vehicle entity, for instance a vehicle trailer or a truck, may be subjected to wind loads during operation. Such wind loads may for instance result in transversal loads imparted on the vehicle entity which may impair the drive behaviour of the vehicle entity. Moreover, the wind loads may result in a wind induced roll moment that may increase the risk for roll-over of the vehicle entity.

To this end, according to its abstract, US 2018/0162400 A1 discloses that one or more devices, systems, and/or methods for controlling a motor vehicle based upon wind are provided. For example, a first measurement of wind detected by a first sensor coupled to the motor vehicle may be received from the first sensor. A second measurement of wind associated with a location of the motor vehicle may be received from a server. A wind effect (e.g., cost, inefficiency, danger, etc.) on the motor vehicle may be determined based upon the first measurement of wind and/or the second measurement of wind. A corrective action for the motor vehicle may be determined based upon the wind effect, and may be implemented on the motor vehicle.

Although the US 2018/0162400 A1 method or device may be used for controlling a vehicle whilst taking wind loads into account, there is still a need for further development within the technical field of vehicle control in response to wind induced loads.

### SUMMARY

An object according to a first aspect of the present invention is to provide a control system by which it is possible to determine information that can be used for determining wind loads with an appropriate level of accuracy.

As such, a first aspect of the present invention relates to a control system for determining a reference side area for a vehicle entity. The vehicle entity is a vehicle or a vehicle trailer and has a nominal vehicle entity side area. The reference side area is adapted to be multiplied with a side force coefficient for determining a side force parameter proportional to a wind side force load imparted on the vehicle entity and/or to be multiplied with a lift coefficient for determining a lift parameter proportional to a wind lift load imparted on the vehicle entity and/or to be combined with a drag coefficient for determining a drag load imparted on the vehicle entity.

The vehicle entity comprises a load surface adapted to receive a material load such that at least a portion of the material load can be exposed to wind loads. The load surface is associated with a load surface area and a load surface length.

The vehicle entity has a longitudinal extension in a longitudinal direction, a transversal extension in a transversal direction and a vertical extension in a vertical direction such that when the vehicle entity is supported by a horizontally extending ground surface, the vertical direction is parallel to a normal of the horizontally extending ground surface, the longitudinal direction corresponds to an intended direction of travel of the vehicle entity and the transversal direction is perpendicular to each one of the longitudinal direction and the vertical direction.

The load surface area extends in a plane, the normal of which is parallel to the vertical direction. The load surface length extends in the longitudinal direction. Each one of the reference side area and the nominal vehicle entity side area extends in a plane, the normal of which is parallel to the transversal direction.

The control system is adapted to:
receive density information indicative of a density (ρ) of material loaded onto the load surface;
receive weight information indicative of a weight of material loaded onto the load surface;
use the density information, the weight information, the load surface area and the load surface length in order to determine a material load surface area, the material load surface area extending in a plane, the normal of which is parallel to the transversal direction, and
use the material load surface area and the nominal vehicle entity side area in order to determine the reference side area.

The control system in accordance with the first aspect of the present invention implies that a reference side area may be determined taking prevailing conditions of the vehicle entity into account. As such, rather than using a predetermined value of the reference side area when determining wind loads imparted on the vehicle entity, the control system according to the first aspect of the present invention may determine a reference side area that better reflects the actual condition of the vehicle entity. Since a wind load determined using a side force or lift equation generally is proportional to the magnitude of the reference side area, an improved estimate of the reference side area may result in improved estimates of the wind loads imparted on the vehicle entity, as compared to the wind loads that are determined under the assumption that the reference side area is a predetermined value.

Optionally, the control system is adapted to:
determine a material load surface area portion that is not covered by the vehicle entity, as seen in the transversal direction, and
add the material load surface area portion to the nominal vehicle entity side area in order to determine the reference side area.

The above implies and appropriate estimate of the reference side area.

Optionally, the control system is adapted to:
use the density information, the weight information and the load surface area to thereby determine a height of the material load, and
use the height of the material load and the load surface length in order to determine the material load surface area.

Optionally, the control system is adapted to use a parameter indicative of a width of the vehicle entity in the transversal direction and to determine the side force coefficient on the basis of at least the width of the vehicle entity and the height of the material load.

The side force coefficient is generally dependent on the shape of the body subject to the wind load. For instance, a body having a square cross-sectional shape has a side force coefficient being different from the side force coefficient of a body having an elongate cross-sectional shape. As such, the above-mentioned feature to determine the side force coefficient may further improve the quality of the wind load using the reference side area and the side force coefficient.

Optionally, the control system is adapted to receive wind information for a wind condition currently acting on the vehicle entity. The wind information is indicative of a wind speed, relative to the vehicle entity, and a wind heading, relative to the vehicle entity. The control system is adapted to use the wind information, the reference side area and the side force coefficient for determining a wind side force load imparted on the vehicle entity. Preferably, the wind side force load comprises a wind-imparted roll moment around a roll axle which is parallel to the longitudinal direction.

Optionally, the control system is adapted to receive wind information for a wind condition currently acting on the vehicle entity, the wind information being indicative of a wind speed, relative to the vehicle entity, and a wind heading, relative to the vehicle entity. The control system is adapted to use the wind information, the reference side area and the lift coefficient for determining a wind lift load imparted on the vehicle entity.

Optionally, the vehicle entity comprises a wind sensor adapted to determine the wind information. The control system is adapted to receive the wind information from the wind sensor.

Optionally, the vehicle entity comprises a density input unit via which an operator can enter the density information. The control system is adapted to receive the density information from the density input unit.

Optionally, the control system is adapted to determine a vertical centre and/or a longitudinal centre of the reference side area on the basis of at least the nominal vehicle entity side area, the density information, the weight information and the load surface area. Information indicative of the vertical centre and/or the longitudinal centre may be useful when for instance determining one or more wind induced moments, e.g. a roll moment using the vertical centre or a yaw moment using the longitudinal centre, imparted on the vehicle entity.

Optionally, the vehicle entity comprises a suspension system and the control system is adapted to receive information from and/or to issue information to the suspension system.

Optionally, the control system is adapted to use information from the suspension system as the weight information. The above possibility implies that the need for using separate or dedicated weight sensors may be omitted.

Optionally, the control system is adapted to issue information to the suspension system in dependence on the determined wind side force load imparted on the vehicle entity.

Optionally, the control system is adapted to, in response to detecting that the wind side force load imparted on the vehicle entity results in a rollover risk exceeding a predetermined risk threshold, issue information to the suspension system such that the vehicle entity assumes a condition with a static inclination towards a windward side of the vehicle entity.

A second aspect of the present invention relates to a vehicle entity being a vehicle or a vehicle trailer and having a nominal vehicle entity side area. The vehicle entity comprises a load surface adapted to receive a material load such that at least a portion of the material load can be exposed to wind loads. The load surface is associated with a load surface area and a load surface length.

The vehicle entity has a longitudinal extension in a longitudinal direction, a transversal extension in a transversal direction and a vertical extension in a vertical direction such that when the vehicle entity is supported by a horizontally extending ground surface, the vertical direction is parallel to a normal of the horizontally extending ground surface, the longitudinal direction corresponds to an intended direction of travel of the vehicle entity and the transversal direction is perpendicular to each one of the longitudinal direction and the vertical direction.

The load surface area extends in a plane, the normal of which is parallel to the vertical direction, the load surface length extending in the longitudinal direction, each one of the reference side area and the nominal vehicle entity side area extending in a plane, the normal of which is parallel to the transversal direction.

The vehicle entity comprises a control system according to the first aspect of the present invention.

Optionally, the vehicle entity comprises a suspension system adapted to issue information indicative of the condition of the suspension system.

Optionally, the vehicle entity comprises a wind sensor adapted to determine wind information for a wind load currently imparted on the vehicle entity, the wind information being indicative of a wind speed, relative to the vehicle entity, and a wind heading, relative to the vehicle entity.

Optionally, the vehicle entity comprises a density input unit via which an operator can enter the density information.

A third aspect according to the present invention relates to a method for determining a reference side area for a vehicle entity. The vehicle entity is a vehicle or a vehicle trailer and has a nominal vehicle entity side area. The reference side area is adapted to be multiplied with a side force coefficient for determining a side force parameter proportional to a wind side force load imparted on the vehicle entity and/or to be multiplied with a lift coefficient for determining a lift parameter proportional to a wind lift load imparted on the vehicle entity and/or to be combined with a drag coefficient for determining a drag load imparted on the vehicle entity. The vehicle entity comprises a load surface adapted to receive a material load such that at least a portion of the material load can be exposed to wind loads. The load surface is associated with a load surface area and a load surface length.

The vehicle entity has a longitudinal extension in a longitudinal direction, a transversal extension in a transversal direction and a vertical extension in a vertical direction such that when the vehicle entity is supported by a horizontally extending ground surface, the vertical direction is parallel to a normal of the horizontally extending ground surface, the longitudinal direction corresponds to an intended direction of travel of the vehicle entity and the transversal direction is perpendicular to each one of the longitudinal direction and the vertical direction.

The load surface area extends in a plane, the normal of which is parallel to the vertical direction. The load surface length extends in the longitudinal direction. Each one of the reference side area and the nominal vehicle entity side area extends in a plane, the normal of which is parallel to the transversal direction.

The method comprises:
receiving density information indicative of a density of material loaded onto the load surface;
receiving weight information indicative of a weight of material loaded onto the load surface;
using the density information, the weight information, the load surface area and the load surface length in order to determine a material load surface area, the material load surface area extending in a plane, the normal of which is parallel to the transversal direction, and
using the material load surface area and the nominal vehicle entity side area in order to determine the reference side area.

Optionally, the method further comprises:
determining a material load surface area portion that is not covered by the vehicle entity, as seen in the transversal direction, and
adding the material load surface area portion to the nominal vehicle entity side area in order to determine the reference side area.

Optionally, the method comprises:
using the density information, the weight information and the load surface area to thereby determine a height of the material load, and
using the height of the material load and the load surface length in order to determine the material load surface area.

Optionally, the method further comprises using a parameter indicative of a width of the vehicle entity in the transversal direction and determining the side force coefficient on the basis of at least the width of the vehicle entity and the height of the material load.

Optionally, the method further comprises receiving wind information for a wind condition currently acting on the vehicle entity, the wind information being indicative of a wind speed, relative to the vehicle entity, and a wind heading, relative to the vehicle entity. The method comprises using the wind information, the reference side area and the side force coefficient for determining a wind side force load imparted on the vehicle entity. Preferably, the wind side force load comprises a wind-imparted roll moment around a roll axle which is parallel to the longitudinal direction.

Optionally, the method further comprises receiving wind information for a wind condition currently acting on the vehicle entity. The wind information is indicative of a wind speed, relative to the vehicle entity, and a wind heading, relative to the vehicle entity. The method comprises using the wind information, the reference side area and the lift coefficient for determining a wind lift load imparted on the vehicle entity.

Optionally, the vehicle entity comprises a wind sensor adapted to determine the wind information. The method comprises receiving the wind information from the wind sensor.

Optionally, the vehicle entity comprises a density input unit via which an operator can enter the density information. The method comprises receiving the density information from the density input unit.

Optionally, the method comprises determining a vertical centre and/or a longitudinal centre of the reference side area on the basis of at least the nominal vehicle entity side area, the density information, the weight information and the load surface area.

Optionally, the vehicle entity comprises a suspension system and the method comprises receiving information from and/or issuing information to the suspension system.

Optionally, the method comprises using information from the suspension system as the weight information.

Optionally, the method further comprises issuing information to the suspension system in dependence on the determined wind side force load imparted on the vehicle entity.

Optionally, the method comprises, in response to detecting that the wind side force load imparted on the vehicle entity results in a rollover risk exceeding a predetermined risk threshold, issuing information to the suspension system such that the vehicle entity assumes a condition with a static inclination towards a windward side of the vehicle entity.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a side view of a vehicle entity according to an embodiment of the present invention;

FIG. 2 is a rear view of the FIG. 1 vehicle entity;

FIG. 3 is a schematic side view illustrating areas of portions of a vehicle entity;

FIG. 4 is a schematic rear view of a vehicle entity;

FIG. 5 is a schematic rear view of a vehicle entity in a tilted condition, and

FIG. 6 is a flowchart illustrating an embodiment of a method according to the present invention.

### DETAILED DESCRIPTION OF EXAMPLE EMBODIMENTS OF THE INVENTION

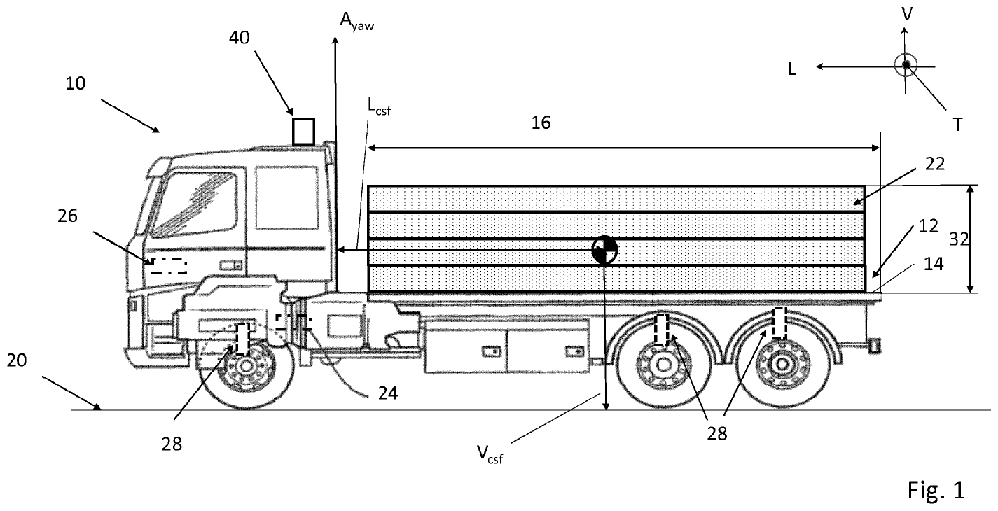

FIG. 1 is a side view of a vehicle entity 10 according to the present invention. In FIG. 1, the vehicle entity 10 is exemplified as a truck. However, it is also envisaged that the vehicle entity 10 according to the present invention may be another type of vehicle, such as a trailer (not shown) or a vehicle combination comprising a tractor and one or more trailers (not shown).

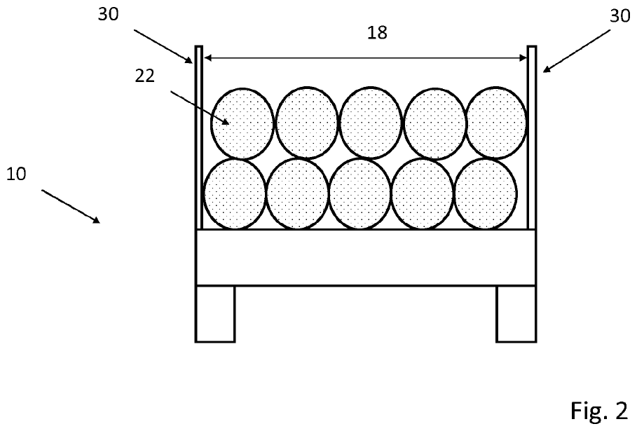

As may be gleaned from FIG. 1, the vehicle entity 10 comprises a load surface 12 adapted to receive a material load such that at least a portion of the material load can be exposed to wind loads. The load surface 12 is associated with a load surface area 14 and a load surface length 16. By way of example, the load surface area 14 may be determined using the load surface length 16 and a load surface width 18 (see FIG. 2), for instance by multiplying the load surface length 16 and the load surface width 18.

Moreover, as indicated in FIG. 1, the vehicle entity 10 has a longitudinal extension in a longitudinal direction L, a transversal extension in a transversal direction T and a vertical extension in a vertical direction V such that when the vehicle entity 10 is supported by a horizontally extending ground surface 20, the vertical direction V is parallel to a normal of the horizontally extending ground surface 20, the longitudinal direction L corresponds to an intended direction of travel of the vehicle entity 10 and the transversal direction T is perpendicular to each one of the longitudinal direction L and the vertical direction V.

The load surface area 14 extends in a plane, the normal of which is parallel to the vertical direction V. It should be noted that the normal of the plane in which the load surface area 14 extends is parallel to the vertical direction V at least when the vehicle entity 10 is in a load receiving condition. As will be elaborated on hereinbelow, the normal of the load surface area plane may form an angle with the vertical direction V in certain operating conditions of the vehicle entity 10.

The load surface length 16 extends in the longitudinal direction L. Each one of the reference side area and the nominal vehicle entity side area extends in a plane, the normal of which is parallel to the transversal direction T.

FIG. 1 and FIG. 2 further illustrate that the vehicle entity 10 can be loaded with a material load 22 which in FIG. 1 and FIG. 2 is exemplified as timber. However, it is of course contemplated that the material load 22 may comprise or be constituted by other materials, such as rocks and/or gravel.

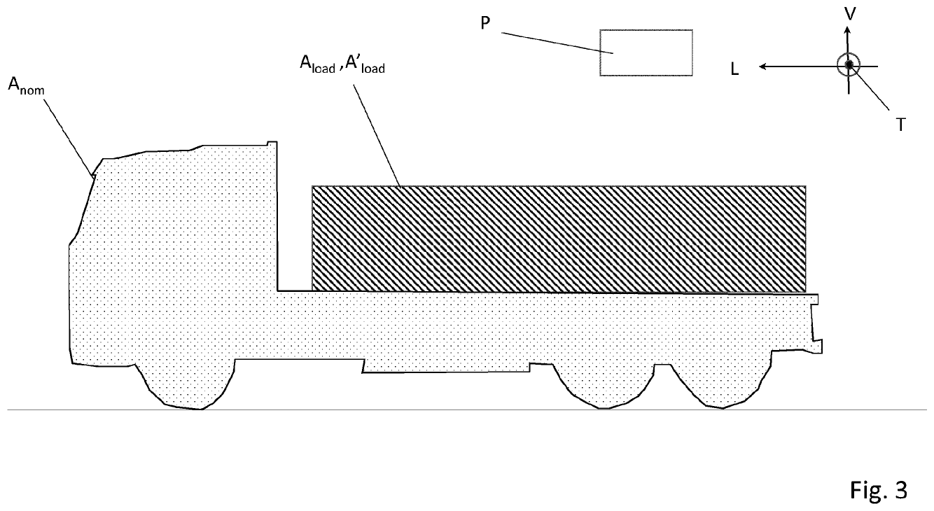

Moreover, as indicated in FIG. 3, the vehicle entity 10 has a nominal vehicle entity side area Aₙₒₘ which is the side area of the vehicle entity 10 when it does not carry any load. Further, when the vehicle entity 10 is loaded with a material load, the material load has a material load surface area A_{load} as also indicated in FIG. 3.

Reverting to FIG. 1, the vehicle entity 10 comprises a control system 24 for determining a reference side area A_{ref} for the vehicle entity 10. The reference side area A_{ref} is adapted to be multiplied with a side force coefficient Cₛ for determining a side force parameter CₛA_{ref} proportional to a wind side force load F_{side_force} imparted on the vehicle entity 10 and/or to be multiplied with a lift coefficient Cₗ for determining a lift parameter CₗA_{ref} proportional to a wind lift load F_{lift} imparted on the vehicle entity 10 and/or to be combined with a drag coefficient C_{d} for determining a drag load F_{drag} imparted on the vehicle entity 10.

As a general remark, it should be noted that the presentation of the control system 24 according to the present invention is equally applicable to the method of the present invention. Moreover, as a further general remark, although the control system 24 is schematically illustrated as a control unit in FIG. 1, the control system 24 in accordance with the present invention may comprise one or more control units (not shown) connected to each other and operating together.

According to the invention, the control system 24 is adapted to receive density information indicative of a density ρ of material 22 loaded onto the load surface 12. Purely by way of example, the vehicle entity 10 may comprise a density input unit 26 via which an operator can enter the density information. The control system 24 may be adapted to receive the density information from the density input unit 26. However, it is also envisaged that the density information may be received using other means. As a first non-limiting example, the density information may be determined using a system (not shown) that comprises an image sensor, such as a camera, which captures one or more images of the material load to be loaded onto the load surface 12 and which determines density information on the basis of the one or more images. As a second non-limiting example, the density information may be determined using a system (not shown) that comprises a position sensor adapted to determine the current position of the vehicle entity 10 and the system may determine the density information on the basis of position density information associated with the thus determined current position.

Moreover, the control system 24 is adapted to receive weight information indicative of a weight wₘₐₜₑᵣᵢₐₗ of material loaded onto the load surface 12. To this end, though purely by way of example, the vehicle entity 10 may comprise a suspension system 28 and the control system 24 may be adapted to receive information from and/or to issue information to the suspension system 28. The suspension system may be a wheel suspension system as indicated in FIG. 1.

For instance, concerning the above-mentioned weight information, the control system 24 may be adapted to use information from the suspension system 28 as the weight information. Purely by way of example, the control system 24 may be adapted to receive information indicative of the pressure in one or more bellows (not shown) of the suspension system 28 before and after material 22 has been loaded onto the load surface 12 and from the differences between the two pressures determine the weight wₘₐₜₑᵣᵢₐₗ of material 22 loaded onto the load surface 12. As such, in the above example, the weight information comprises, or may even be constituted by, the pressure information from the suspension system 28.

However, it is contemplated that embodiments of the control system 24 may use other means for determining the weight wₘₐₜₑᵣᵢₐₗ of material 22 loaded onto the load surface 12.

Purely by way of example, it is envisaged that embodiments of the control system 24 may be adapted to receive information from weighing scales (not shown), such as load cells, onto which the vehicle entity 10 is adapted to be located such that the scales or load cells can determine the weight wₘₐₜₑᵣᵢₐₗ of material 22 loaded onto the load surface 12.

Further, the control system 24 is adapted to use the density information, the weight information, the load surface area 14 and the load surface length 16 in order to determine a material load surface area A_{load} (see FIG. 3). The material load surface area A_{load} extends in a plane P, the normal of which is parallel to the transversal direction T. Moreover, the control system 24 is adapted to use the material load surface area A_{load} and the nominal vehicle entity side area Aₙₒₘ in order to determine the reference side area A_{ref}.

For the sake of completeness, it should be noted that each one of the reference side area A_{ref} and the nominal vehicle entity side area Aₙₒₘ also extends in the plane P, the normal of which is parallel to the transversal direction T.

As a non-limiting example, with reference to FIG. 3, the control system 24 may be adapted to determine a material load surface area portion A′_{load} that is not covered by the vehicle entity 10, as seen in the transversal direction T. In FIG. 3, the material load surface area portion A′_{load} is equal to the material load surface area A_{load} since the vehicle entity 10 does not comprise any side panels or the like that covers any portion of the load 22. To this end, it should be noted that the stands 30 (see FIG. 2) are deemed to have a negligible side area. However, in other embodiments of the vehicle entity 10, the material load surface area portion A′_{load} may be smaller than the material load surface area A_{load}-Moreover, the control system 24 may be adapted to add the material load surface area portion A′_{load} to the nominal vehicle entity side area Aₙₒₘ in order to determine the reference side area A_{ref}. Put differently, the reference side area A_{ref} may be determined in accordance with the following: A_{ref}=Aₙₒₘ+A′_{load}.

Purely by way of example, as exemplified in FIG. 1, the control system 24 may be adapted to:
use the density information, the weight information and the load surface area 14 to thereby determine a height 32 of the material load, and
use the height 32 of the material load and the load surface length 16 in order to determine the material load surface area A_{load}.

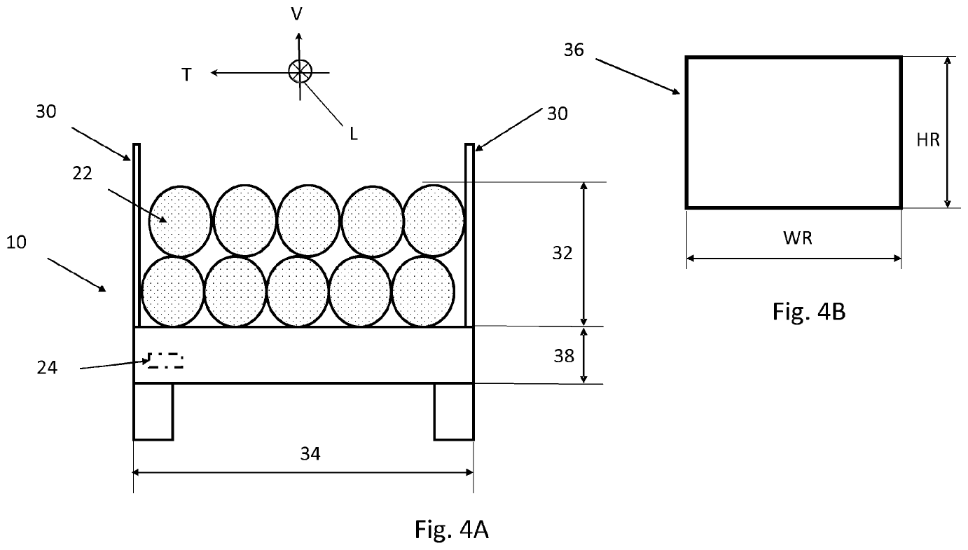

Moreover, with reference to FIG. 4A and FIG. 4B, the control system 24 may be adapted to use a parameter indicative of a width 34 of the vehicle entity 10 in the transversal direction T and to determine the side force coefficient Cₛ on the basis of at least the width 34 of the vehicle entity 10 and the height 32 of the material load.

As indicated in FIG. 4A and FIG. 4B, the shape of the vehicle entity 10 and the material load 22 in a plane formed by the transversal direction T and the vertical direction V may be approximated by a rectangle 36 having a width WR being equal to the width 34 of the vehicle entity 10 and a height HR being equal to the sum of the height 32 of the material load and a height 38 of a side portion of the vehicle entity 10. The ratio WR/HR between the width WR and the height HR of the rectangle 36 may be used for determining a side force coefficient Cₛ for the vehicle entity 10. Purely by way of example, the values in the table presented hereinbelow may be used for determining the side force coefficient Cₛ, assuming that the vehicle entity 10 can be approximated as a rectangle with sharp corners.

| WR/HR | Cₛ |
|---|---|
| 0.1 | 1.9 |
| 0.5 | 2.5 |
| 0.7 | 2.7 |
| 1.0 | 2.2 |
| 2.0 | 1.7 |
| 3.0 | 1.3 |

It should be noted that the values in the above table are only intended to serve as examples for illustrating that the value of the side force coefficient Cₛ may be dependent on the ratio WR/HR between the width WR and the height HR of the rectangle 36. In other embodiments of the present invention, other values may be used and/or the side force coefficient Cₛ may for instance be determined using a function rather than a table.

Reverting to FIG. 1, the control system 24 may be adapted to receive wind information for a wind condition currently acting on the vehicle entity 10. As a non-limiting example presented in FIG. 1, the vehicle entity 10 may comprise a wind sensor 40 adapted to determine the wind information and the control system 24 may be adapted to receive the wind information from the wind sensor 40. However, in other embodiments of the present invention, the control system 24 may be adapted to receive the wind information from other types of information sources. As a non-limiting example, the control system may be adapted to receive wind information from weather services issuing the wind information.

Irrespective of how it is determined, the wind information may be indicative of a wind speed, relative to the vehicle entity 10, and a wind heading, relative to the vehicle entity 10. In embodiments of the invention, the control system 24 is adapted to use the wind information, the reference side area A_{ref} and the side force coefficient Cₛ for determining a wind side force load imparted on the vehicle entity 10. As a non-limiting example, the wind side force load F_{side_force} may be determined in accordance with the following:

$${F}_{side\_force} = \frac{1}{2} ρ {u}^{2} {C}_{s} {A}_{ref} \qquad ( Eq . 1 )$$

wherein:
ρ is the density of air;
u is the wind speed in a direction perpendicular to the reference side area A_{ref};
Cₛ is the side force coefficient, and
A_{ref} is the reference side area.

Purely by way of example, the side force coefficient Cₛ may be determined in accordance with the above presentation, such as using a table or an equation. However, it is also contemplated that in embodiments of the control system 24, a fixed value for the side force coefficient Cₛ may be used.

Since the wind speed u in a direction perpendicular to the reference side area A_{ref} is used in Eq. 1 above, a wind speed v_{wind}, relative to the vehicle entity 10, and a wind heading θ_{wind}, relative to the vehicle entity 10, may be used for determining the wind speed u in a direction perpendicular to the reference side area A_{ref}. As non-limiting example, assuming that the wind heading θ_{wind}, relative to the vehicle entity 10, relates to the angle that is formed between a propagating direction of the wind and the longitudinal direction L, the wind speed u to be used in Eq. 1 may be determined in accordance with the following:

$$u = {v}_{wind} sin ( {θ}_{wind} ) \qquad ( Eq . 2 )$$

For the sake of completeness, it should be noted that the wind speed v_{wind}, relative to the vehicle entity 10, may be referred to as a “apparent wind” being the wind experienced by the vehicle 10 motion. As such, the apparent wind may be regarded as the sum of the wind speed a moving object would experience in still air plus the velocity of the true wind.

It should be noted that in other implementations of the wind sensor 40, the wind sensor 40 may be adapted to only detect the wind speed in the direction perpendicular to the reference side area A_{ref}. In such implementations, Eq. 2 above needs not necessarily be used. Instead, the wind speed v_{wind} detected by the wind sensor 40 may be used directly as u in Eq. 1.

The wind side force load F_{side_force} is a load imparted on the vehicle entity 10 in a direction perpendicular to the reference side area A_{ref}. As such, the wind side force load F_{side_force} will generally extend in a direction parallel to the transversal direction T.

However, when wind acts on the vehicle entity 10, due to e.g. the gap between the vehicle entity 10 and the horizontally extending ground surface 20, the vehicle entity 10 may be imparted a lift force F_{lift} that extends in the vertical direction V and which may be calculated in accordance with the following:

$${F}_{lift} = \frac{1}{2} ρ {u}^{2} {C}_{l} {A}_{r e f} \qquad ( Eq . 3 )$$

wherein:
ρ is the density of air;
u is the wind speed in a direction perpendicular to the reference side area A_{ref},
Cₗ is the lift coefficient, and
A_{ref} is the reference side area.

As for the side force coefficient Cₛ, the lift coefficient Cₗ may be determined using a table or an equation. However, it is also contemplated that in embodiments of the control system 24, a fixed value for the lift coefficient C/may be used.

Reverting to the wind side force load, it preferably comprises a wind-imparted roll moment M_{wind} around a roll axle being parallel to the longitudinal direction L. Purely by way of example, the wind-imparted roll moment M_{wind} may be calculated in accordance with the following:

$${M}_{wind} = \frac{1}{2} ρ {u}^{2} {C}_{s} {A}_{r e f} {V}_{c} \qquad ( Eq . 4 )$$

wherein:
V_{c} is the vertical centre of the reference side area A_{ref}, see e.g. FIG. 1.

As such, again with reference to FIG. 1, the control system 24 may be adapted to determine a vertical centre V_{c} and/or a longitudinal centre L_{c} of the reference side area A_{ref} on the basis of at least the nominal vehicle entity side area Aₙₒₘ, the density information, the weight information and the load surface area 14. If the longitudinal centre L_{c} is used in Eq. 4 instead of the vertical centre V_{c}, Eq. 4 would be representative for a yaw moment around a yaw axis A_{yaw} that may extend in the vertical direction V, see FIG. 1.

It should also be noted that in embodiments of the control system, the wind-imparted roll moment M_{wind} may be determined using e.g. a combination of the wind side force load F_{side_force} and the wind lift force F_{lift}.

In the above example equations in Eq. 1-Eq. 4, the side force load F_{side_force} for instance has been determined using information indicative of the reference side area A_{ref} as well as a wind speed in a direction perpendicular to the reference side area A_{ref}. However, it is also contemplated that the reference side area A_{ref} may be used for calculating the side force load F_{side_force} for instance using other equations.

Purely by way of example, it is envisaged that the side force coefficient Cₛ (θ_{wind}) may be dependent on the wind heading θ_{wind}, relative to the vehicle entity 10. In a similar vein, the area A (θ_{wind}) exposed to the wind may also be dependent on the wind heading θ_{wind}, relative to the vehicle entity 10. Here, it should be noted that the reference side area A_{ref} may be used when determining the area A (θ_{wind}) exposed to the wind. Purely by way of example, for a wind heading θ_{wind} of 90°, indicating a wind from the side of the vehicle 10, the area A (θ_{wind}) exposed to the wind may equal the reference side area A_{ref}. On the other hand, for a wind heading θ_{wind} of 0°, indicating a wind from the front of the vehicle 10, the area A (θ_{wind}) exposed to the wind may be independent of the reference side area A_{ref}. Moreover, for wind headings θ_{wind} between 0° and 90°, the area A (θ_{wind}) exposed to the wind may be determined using the reference side area A_{ref} and trigonometric functions. As such, the side force load F_{side_force} for a certain wind heading θ_{wind} may be determined in accordance with the following:

$${F}_{side\_force} = \frac{1}{2} ρ {u}^{2} {C}_{s} ( {θ}_{wind} ) A ( {θ}_{wind} ) \qquad ( Eq . 5 )$$

It should be noted that the calculation of the side force load F_{side_force} as exemplified in Eq. 5 hereinabove also may be applicable to the determination of the lift force F_{lift}, a drag force F_{drag} and/or a wind-imparted roll moment M_{wind}. As such, in embodiments of the control system 24 and/or the method of the present invention, the lift force F_{lift} may be determined in accordance with the following:

$${F}_{lift} = \frac{1}{2} ρ {u}^{2} {C}_{l} ( {θ}_{wind} ) A ( {θ}_{wind} ) \qquad ( Eq . 6 )$$

wherein:
ρ is the density of air;
u is the wind speed, associated with a certain wind heading θ_{wind};
Cₗ is the lift coefficient as a function of the wind heading θ_{wind}, and
A is the area exposed to the wind as a function of the wind heading θ_{wind}.

In a similar vein, a drag force F_{drag} may be determined in accordance with Eq. 7 presented hereinbelow. A drag force F_{drag} is generally a load acting in the longitudinal direction L of the vehicle 10 and may be defined as a force acting in a direction opposite to the direction of travel of the vehicle 10.

$${F}_{drag} = \frac{1}{2} ρ {u}^{2} {C}_{d} ( {θ}_{wind} ) A ( {θ}_{wind} ) \qquad ( Eq . 7 )$$

wherein:
ρ is the density of air;
u is the wind speed, associated with a certain wind heading θ_{wind};
C_{d} is the drag coefficient as a function of the wind heading θ_{wind}, and
A is the area exposed to the wind as a function of the wind heading θ_{wind}.

As has been explained hereinabove, the area A exposed to the wind as a function of the wind heading θ_{wind} may be determined using the reference side area A_{ref}.

In a similar vein, though purely by way of example, the wind-imparted roll moment M_{wind} may be determined in accordance with the following:

$${M}_{wind} = \frac{1}{2} ρ {u}^{2} {C}_{s} ( {θ}_{wind} ) A ( {θ}_{wind} ) {V}_{c} ( {θ}_{wind} ) \qquad ( Eq . 8 )$$

wherein:
V_{c} is the vertical centre of the area exposed to the wind.

It should be noted that the vertical centre V_{c} of the area exposed to the wind as presented in Eq. 8 may also be dependent on the wind heading θ_{wind}.

As may be realized from the above, wind induced forces and/or moments may be determined in a plurality of different ways. However, it is generally beneficial to obtain information indicative of the reference side area A_{ref} when performing such determinations.

As has been intimated hereinabove, the vehicle entity 10 may comprise a suspension system 28 and the control system 24 may be adapted to receive information from and/or to issue information to the suspension system 28. Purely by way of example, the control system 24 may be adapted to use information from the suspension system as the weight information.

Instead of, or in addition to, receiving information from the suspension system 28, the control system 24 may be adapted to issue information to the suspension system 28 in dependence on the determined wind side force load F_{side_force} imparted on the vehicle entity 10.

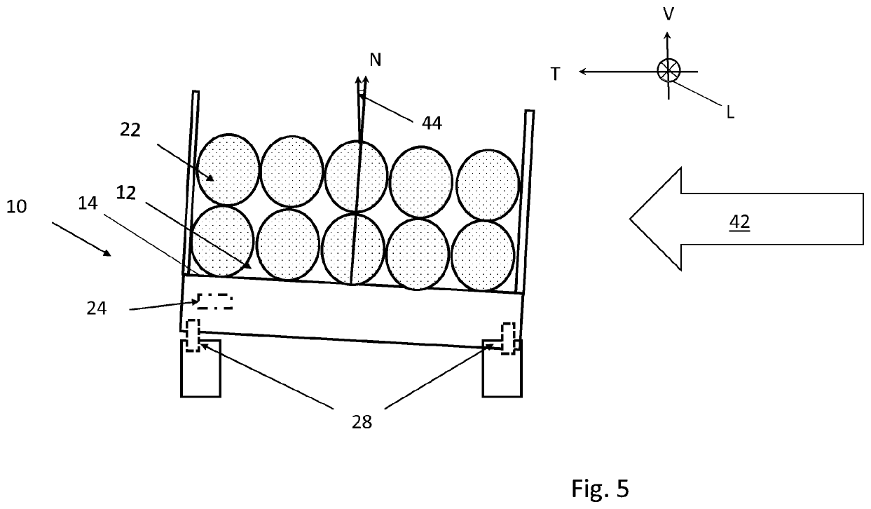

With reference to FIG. 5, though purely by way of example, the control system 24 may be adapted to, in response to detecting that the wind side force load, such as a wind-imparted roll moment M_{wind} imparted on the vehicle entity 10 results in a rollover risk exceeding a predetermined risk threshold, issue information to the suspension system 28 such that the vehicle entity 10 assumes a condition with a static inclination towards a windward side of the vehicle entity 10.

As may be gleaned from FIG. 5, and has been intimated above, the load surface area 14 extends in a plane, the normal N of which generally is parallel to the vertical direction V. However, when subjected to wind, indicated by arrow 42 in FIG. 5, which is deemed to result in a rollover risk exceeding a predetermined risk threshold, the control system 24 may be adapted to issue information to the suspension system 28 such that at least the load surface 12 is tilted towards the wind 42 such that the normal N of the load surface area 14 forms an angle 44 to the vertical direction V. Such an orientation of the load surface 12 may reduce the rollover risk. As a non-limiting example, the angle 44 may be within the range of 1°-5°.

Instead of, or in addition to, tilting the load surface 12, the control system 24 may be adapted to one or more other actions in response to detecting a rollover risk exceeding a predetermined risk threshold. Purely by way of example, the control system 24 may be adapted to issue a warning signal to the operator of the vehicle 10. As another non-limiting example, the control system 24 may reduce the maximum allowable speed for the vehicle or, alternatively, reduce the current speed of the vehicle 10.

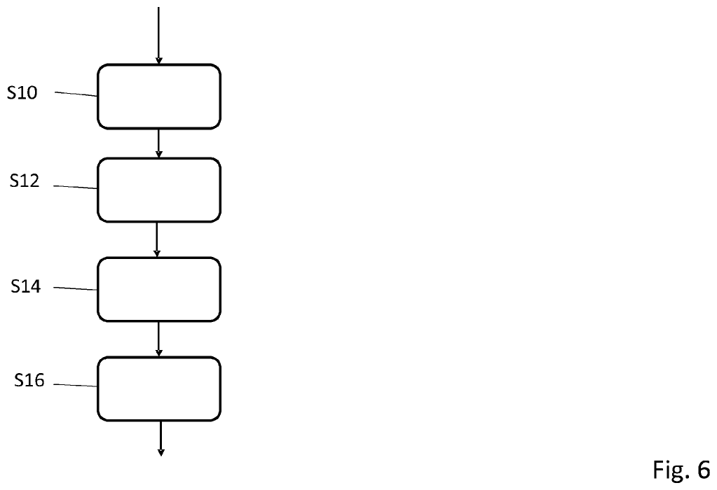

As has been concluded above, the above presentation is equally applicable to the method of the present invention. However, for the sake of completeness, FIG. 6 presents a flowchart illustrating an embodiment of the method according to the present invention.

As such, FIG. 6 is a flowchart of a method for determining a reference side area A_{ref} for a vehicle entity 10. The vehicle entity 10 is a vehicle or a vehicle trailer and has a nominal vehicle entity side area Aₙₒₘ. The reference side area A_{ref} is adapted to be multiplied with a side force coefficient Cₛ for determining a side force parameter proportional to a wind side force load imparted on the vehicle entity 10 and/or to be multiplied with a lift coefficient Cₗ for determining a lift parameter proportional to a wind lift load imparted on the vehicle entity and/or to be combined with a drag coefficient C_{d} for determining a drag load F_{drag} imparted on the vehicle entity 10. The vehicle entity 10 comprises a load surface 12 adapted to receive a material load 22 such that at least a portion of the material load 22 can be exposed to wind loads. The load surface 12 is associated with a load surface area 14 and a load surface length 16.

The vehicle entity 10 has a longitudinal extension n a longitudinal direction L, a transversal extension in a transversal direction T and a vertical extension in a vertical direction V such that when the vehicle entity 10 is supported by a horizontally extending ground surface, the vertical direction V is parallel to a normal of the horizontally extending ground surface. The longitudinal direction L corresponds to an intended direction of travel of the vehicle entity and the transversal direction T is perpendicular to each one of the longitudinal direction L and the vertical direction V.

The load surface area 14 extends in a plane, the normal of which is parallel to the vertical direction V. The load surface length 16 extends in the longitudinal direction. Each one of the reference side area A_{ref} and the nominal vehicle entity side area Aₙₒₘ extends in a plane P, the normal of which is parallel to the transversal direction T.

With reference to FIG. 6, the method comprises:
S10: receiving density information indicative of a density ρ of material loaded onto the load surface 12;
S12: receiving weight information indicative of a weight wₘₐₜₑᵣᵢₐₗ of material loaded onto the load surface 12;
S14: using the density information, the weight information, the load surface area 14 and the load surface length 16 in order to determine a material load surface area A_{load}, the material load surface area A_{load} extending in a plane P, the normal of which is parallel to the transversal direction T, and
S16: using the material load surface area A_{load} and the nominal vehicle entity side area Aₙₒₘ in order to determine the reference side area A_{ref}.

It is to be understood that the present invention is not limited to the embodiments described above and illustrated in the drawings; rather, the skilled person will recognize that many changes and modifications may be made within the scope of the appended claims.

1. A control system for determining a reference side area for a vehicle entity, the vehicle entity being a vehicle or a vehicle trailer and having a nominal vehicle entity side area, the reference side area being adapted to be multiplied with a side force coefficient for determining a side force parameter proportional to a wind side force load imparted on the vehicle entity and/or to be multiplied with a lift coefficient for determining a lift parameter proportional to a wind lift load imparted on the vehicle entity and/or to be combined with a drag coefficient for determining a drag load imparted on the vehicle entity, the vehicle entity comprising a load surface adapted to receive a material load such that at least a portion of the material load can be exposed to wind loads, be load surface being associated with a load surface area and a load surface length;
the vehicle entity having a longitudinal extension in a longitudinal direction, a transversal extension in a transversal direction, and a vertical extension in a vertical direction such that when the vehicle entity is supported by a horizontally extending ground surface, the vertical direction is parallel to a normal of the horizontally extending ground surface, the longitudinal direction corresponding to an intended direction of travel of the vehicle entity and the transversal direction being perpendicular to each one of the longitudinal direction and the vertical direction; and
the load surface area extending in a plane, the normal of which is parallel to the vertical direction, the load surface length extending in the longitudinal direction, each one of the reference side area and the nominal vehicle entity side area extending in a plane, the normal of which is parallel to the transversal direction, the control system being adapted to:
receive density information indicative of a density of material loaded onto the load surface;
receive weight information indicative of a weight of material loaded onto the load surface;
use the density information, the weight information, the load surface area and the load surface length in order to determine a material load surface area the material load surface area extending in a plane, the normal of which is parallel to the transversal direction; and
use the material load surface area and the nominal vehicle entity side area in order to determine the reference side area.

2. The control system of claim 1, wherein the control system is adapted to:
determine a material load surface area portion that is not covered by the vehicle entity, as seen in the transversal direction; and
add the material load surface area portion to the nominal vehicle entity side area in order to determine the reference side area.

3. The control system of claim 1, wherein the control system is adapted to:
use the density information, the weight information and the load surface area to thereby determine a height of the material load; and
use the height of the material load and the load surface length in order to determine the material load surface area.

4. The control system of claim 3, wherein the control system is adapted to use a parameter indicative of a width of the vehicle entity in the transversal direction and to determine the side force coefficient on the basis of at least the width of the vehicle entity and the height of the material load.

5. The control system of claim 1, wherein the control system is adapted to receive the wind information for a wind condition currently acting on the vehicle entity, the wind information being indicative of a wind speed, relative to the vehicle entity, and a wind heading, relative to the vehicle entity, the control system being adapted to use the wind information, the reference side area and the side force coefficient for determining a wind side force load imparted on the vehicle entity, preferably the wind side force load comprising a wind-imparted roll moment around a roll axle being parallel to the longitudinal direction.

6. The control system of claim 1, wherein the control system is adapted to receive wind information for a wind condition currently acting on the vehicle entity, the wind information being indicative of a wind speed, relative to the vehicle entity, and a wind heading, relative to the vehicle entity, the control system being adapted to use the wind information, the reference side area and the lift coefficient for determining a wind lift load imparted on the vehicle entity.

7. The control system of claim 5, wherein the vehicle entity comprises a wind sensor adapted to determine the wind information, the control system being adapted to receive the wind information from the wind sensor.

8. The control system of claim 1, wherein the vehicle entity comprises a density input unit via which an operator can enter the density information, the control system being adapted to receive the density information from the density input unit.

9. The control system of claim 1, wherein the control system is adapted to determine a vertical center and/or a longitudinal center of the reference side area on the basis of at least the nominal vehicle entity side area, the density information, the weight information and the load surface area.

10. The control system of claim 1, wherein the vehicle entity comprises a suspension system and wherein the control system is adapted to receive information from and/or to issue information to the suspension system.

11. The control system of claim 10, wherein the control system is adapted to use information from the suspension system as the weight information.

12. The control system of claim 10, wherein the control system is adapted to receive wind information for a wind condition currently acting on the vehicle entity, the wind information being indicative of a wind speed, relative to the vehicle entity, and a wind heading, relative to the vehicle entity, the control system being adapted to use the wind information, the reference side area and the side force coefficient for determining a wind side force load imparted on the vehicle entity, preferably the wind side force load comprising a wind-imparted roll moment around a roll axle being parallel to the longitudinal direction, and, wherein the control system is further adapted to issue information to the suspension system in dependence on the determined wind side force load imparted on the vehicle entity.

13. The control system of claim 12, wherein the control system is adapted to, in response to detecting that the wind side force load imparted on the vehicle entity results in a rollover risk exceeding a predetermined risk threshold, issue information to the suspension system such that the vehicle entity assumes a condition with a static inclination towards a windward side of the vehicle entity.

14. A vehicle entity being a vehicle or a vehicle trailer and having a nominal vehicle entity side area, the vehicle entity comprising a load surface adapted to receive a material load such that at least a portion of the material load can be exposed to wind loads, the load surface being associated with a load surface area and a load surface length;
the vehicle entity having a longitudinal extension in a longitudinal direction, a transversal extension in a transversal direction and a vertical extension in a vertical direction such that when the vehicle entity is supported by a horizontally extending ground surface, the vertical direction is parallel to a normal of the horizontally extending ground surface, the longitudinal direction corresponding to an intended direction of travel of the vehicle entity and the transversal direction being perpendicular to each one of the longitudinal direction and the vertical direction;
the load surface area extending in a plane, the normal of which is parallel to the vertical direction, the load surface length extending in the longitudinal direction, each one of the reference side area and the nominal vehicle entity side area extending in a plane, the normal of which is parallel to the transversal direction; and
the vehicle entity comprising the control system of claim 1.

15. The vehicle entity of claim 14, wherein the vehicle entity comprises a suspension system adapted to issue information indicative of the condition of the suspension system.

16. The vehicle entity of claim 14, wherein the vehicle entity comprises a wind sensor adapted to determine wind information for a wind load currently imparted on the vehicle entity, the wind information being indicative of a wind speed, relative to the vehicle entity, and a wind heading, relative to the vehicle entity.

17. The vehicle entity of claim 14, wherein the vehicle entity comprises a density input unit via which an operator can enter the density information.

18. A method for determining a reference side area for a vehicle entity, the vehicle entity being a vehicle or a vehicle trailer and having a nominal vehicle entity side area, the reference side area being adapted to be multiplied with a side force coefficient for determining a side force parameter proportional to a wind side force load imparted on the vehicle entity and/or to be multiplied with a lift coefficient for determining a lift parameter proportional to a wind lift load imparted on the vehicle entity and/or to be combined with a drag coefficient for determining a drag load imparted on the vehicle entity, the vehicle entity comprising a load surface adapted to receive a material load such that at least a portion of the material load can be exposed to wind loads, the load surface being associated with a load surface area and a load surface length;
the vehicle entity having a longitudinal extension in a longitudinal direction, a transversal extension in a transversal direction and a vertical extension in a vertical direction such that when the vehicle entity is supported by a horizontally extending ground surface, the vertical direction is parallel to a normal of the horizontally extending ground surface the longitudinal direction corresponding to an intended direction of travel of the vehicle entity and the transversal direction being perpendicular to each one of the longitudinal direction and the vertical direction; and
the load surface area extending in a plane, the normal of which is parallel to the vertical direction, the load surface length extending in the longitudinal direction, each one of the reference side area and the nominal vehicle entity side area extending in a plane, the normal of which is parallel to the transversal direction, the method comprising:
receiving density information indicative of a density of material loaded onto the load surface;
receiving weight information indicative of a weight of material loaded onto the load surface;
using the density information, the weight information, the load surface area and the load surface length in order to determine a material load surface area, the material load surface area extending in a plane, the normal of which is parallel to the transversal direction; and
using the material load surface area and the nominal vehicle entity side area in order to determine the reference side area.

19. The method of claim 18, further comprising:
determining a material load surface area portion that is not covered by the vehicle entity, as seen in the transversal direction; and
adding the material load surface area portion to the nominal vehicle entity side area in order to determine the reference side area.

20. The method of claim 18, wherein the method comprises:
using the density information, the weight information and the load surface area to thereby determine a height of the material load; and
using the height of the material load and the load surface length in order to determine the material load surface area.

21. The method of claim 20, further comprising using a parameter indicative of a width of the vehicle entity in the transversal direction and determining the side force coefficient on the basis of at least the width of the vehicle entity and the height of the material load.

22. The method of claim 18, further comprising receiving wind information for a wind condition currently acting on the vehicle entity, the wind information being indicative of a wind speed, relative to the vehicle entity, and a wind heading, relative to the vehicle entity, the method comprising using the wind information, the reference side area and the side force coefficient for determining a wind side force load imparted on the vehicle entity, preferably the wind side force load comprising a wind-imparted roll moment around a roll axle being parallel to the longitudinal direction.

23. The method of claim 18, further comprising receiving wind information for a wind condition currently acting on the vehicle entity, the wind information being indicative of a wind speed, relative to the vehicle entity, and a wind heading, relative to the vehicle entity, the method comprising using the wind information, the reference side area and the lift coefficient for determining a wind lift load imparted on the vehicle entity.

24. The method of claim 22, wherein the vehicle entity comprises a wind sensor adapted to determine the wind information, the method comprising receiving the wind information from the wind sensor.

25. The method of claim 18, wherein the vehicle entity comprises a density input unit via which an operator can enter the density information, the method comprising receiving the density information from the density input unit.

26. The method of claim 18, further comprising determining a vertical center and/or a longitudinal center of the reference side area on the basis of at least the nominal vehicle entity side area, the density information, the weight information and the load surface area.

27. The method of claim 18, wherein the vehicle entity comprises a suspension system and wherein the method comprises receiving information from and/or issuing information to the suspension system.

28. The method of claim 27, wherein the method comprises using information from the suspension system as the weight information.

29. The method of claim 27, further comprising:
receiving wind information for a wind condition currently acting on the vehicle entity, said wind information being indicative of a wind speed, relative to the vehicle entity, and a wind heading, relative to the vehicle entity, the method comprising using the wind information, the reference side area and the side force coefficient for determining a wind side force load imparted on the vehicle entity, preferably the wind side force load comprising a wind-imparted roll moment around a roll axle being parallel to the longitudinal direction; and
issuing information to the suspension system in dependence on the determined wind side force load imparted on the vehicle entity.

30. The method of claim 29, wherein the method comprises, in response to detecting that the wind side force load imparted on the vehicle entity results in a rollover risk exceeding a predetermined risk threshold, issuing information to the suspension system such that the vehicle entity assumes a condition with a static inclination towards a windward side of the vehicle entity.
